(19) United States
(12) Patent Application Publication
(10) Pub. No.: US 2023/0045500 A1
(43) Pub. Date: Feb. 9, 2023

(54) APPARATUS AND METHOD FOR CHANGING COLOR PAINTED ON BODY PANEL TO GLOSSY OR MATTE

(71) Applicant: HYUNDAI MOBIS Co., Ltd., Seoul (KR)

(72) Inventor: Byung Pyll LEE, Yongin-si (KR)

(73) Assignee: HYUNDAI MOBIS Co., Ltd., Seoul (KR)

(21) Appl. No.: 17/851,554

(22) Filed: Jun. 28, 2022

(30) Foreign Application Priority Data
Aug. 3, 2021 (KR) 10-2021-0102241

(51) Int. Cl. G02F 1/13; G02F 1/00

(52) U.S. Cl. CPC G02F 1/1313; G02F 1/0045

(57) ABSTRACT

According to the present invention, a color painted on a body panel may be freely changed to glossy or matte according to the individual tastes of a plurality of users or changes in the tastes of a single user.

### CROSS-REFERENCE TO RELATED APPLICATIONS

This application claims the benefit of the Korean Patent Application No. 10-2021-0102241 filed on Aug. 03, 2021, which is hereby incorporated by reference as if fully set forth herein.

### BACKGROUND

### Field of the Invention

The present invention relates to a technology related to exterior painting of a body panel.

### Discussion of the Related Art

Paints having various colors may be sprayed on a body panel to give a variety of colors to a single vehicle model, thereby broadening customer selection for vehicle colors.

Recently, customers who prefer matte colors based on customer need tend to increase. As one of the methods of realizing matte colors, a method of attaching matte paint protection film (PPF) on a painted surface (or paint layer) has been widely used.

Such a matte PPF serves to implement matte by reducing the amount of light passing therethrough.

When a plurality of users, such as a family, use a single vehicle in common, preference for glossy and matte of each user may not match. Therefore, when purchasing a vehicle, if a glossy or matte painting is selected, it is impossible to reflect all the tastes of each user during the life of corresponding painting without additional painting work.

In addition, when one user uses one vehicle alone, preference for glossy and matte may vary depending on circumstances (weather, user's mood, user's clothes, etc.) but cannot be reflected unless the matte PPF is removed or a new painting is done in a related art.

### SUMMARY

An aspect of the present invention is directed to providing an apparatus for freely changing a color painted on a body panel to glossy or matte according to the individual tastes of a plurality of users or changes in the taste of a single user.

To achieve these and other advantages and in accordance with the purpose of the invention, as embodied and broadly described herein, there is provided an apparatus for changing a color painted on a body panel to glossy or matte, including: a liquid crystal film layer attached to the paint layer painted on a body panel; and a power supply configured to supply a voltage to the liquid crystal film layer, wherein the liquid crystal film layer is changed to an opaque state or a transparent state depending on whether the voltage is supplied, scatters and blocks light reflected on the paint layer in the opaque state to change a color of the paint layer into a matte color, and changes the color of the paint layer into a glossy color in the transparent state.

In another aspect of the present invention, there is provided a method for changing a color painted on a body panel to glossy or matte, including: outputting, by a display device, color information selected by a user from among a glossy color and a matte color; supplying, by a power supply, a voltage to a liquid crystal film layer attached to the paint layer painted on a body panel or cutting off the voltage according to the color information; and changing the liquid crystal film layer into an opaque state or a transparent state according to a voltage supplied or cut off from the power supply, and scattering and blocking light reflected from the paint layer in the opaque state to change color of the paint layer to matte color or change color of the paint layer to a glossy color in the transparent state.

In another aspect of the present invention, there is provided a method for changing color painted on a body panel to glossy or matte, including: storing, by an integrated memory system, color information selected by a user in advance from among a glossy color and a matte color; displaying, by a display device, the color information and outputting the color information when the user selects the color information being displayed; supplying, by a power supply, a voltage to a liquid crystal film layer attached to a paint layer painted on the body panel according to the color information or cutting off the voltage; and changing a color of the paint layer to the matte color or the glossy color based on transmittance changed as the voltage supplied from the power supply is supplied or cut off.

It is to be understood that both the foregoing general description and the following detailed description of the present invention are exemplary and explanatory and are intended to provide further explanation of the invention as claimed.

### BRIEF DESCRIPTION OF THE DRAWINGS

FIGS. 1 and 2 are conceptual views illustrating a principle for changing a color painted on a body panel to glossy or matte according to an embodiment of the present invention.

FIG. 3 is a view illustrating an apparatus for changing a color painted on a body panel to glossy or matte according to an embodiment of the present invention.

FIG. 4 is a view illustrating a screen configuration of an input screen provided by a display device shown in FIG. 3.

FIG. 5 is a view illustrating an apparatus for changing a color painted on a body panel to glossy or matte according to another embodiment of the present invention.

FIG. 6 is a flowchart illustrating a method for changing a color painted on a body panel to glossy or matte according to an embodiment of the present invention.

FIG. 7 is a flowchart illustrating a method for changing a color painted on a body panel to glossy or matte color according to another embodiment of the present invention.

### DETAILED DESCRIPTION OF THE INVENTION

Hereinafter, embodiments of the present invention will be described in detail to be easily embodied by those skilled in the art with reference to the accompanying drawings. The present invention may, however, be embodied in many different forms and should not be construed as being limited to the embodiments set forth herein. The present invention may, however, be embodied in many different forms and should not be construed as being limited to the embodiments set forth herein. In the accompanying drawings, a portion irrelevant to a description of the present invention will be omitted for clarity. Like reference numerals refer to like elements throughout. Also, in providing description with reference to the drawings, although elements are represented by the same name, reference numeral referring to the elements may be changed, and reference numerals are merely described for convenience of description. It should not be construed that concepts, features, functions, or effects of elements are limited by reference numerals.

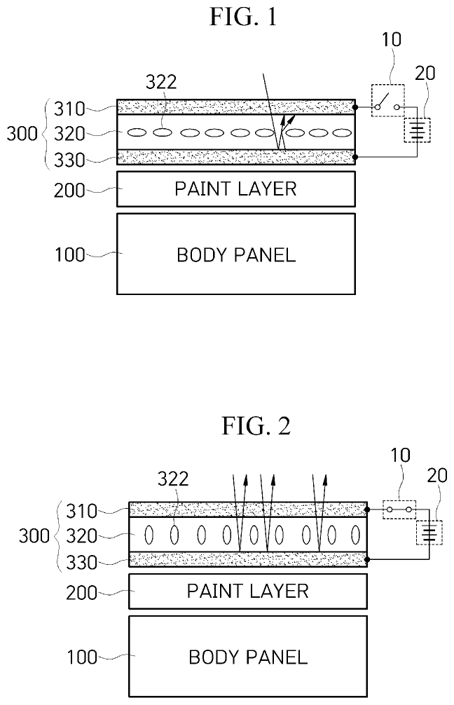

FIGS. 1 and 2 are conceptual views illustrating a principle for changing a color painted on a body panel to glossy or matte according to an embodiment of the present invention. For better understanding of the invention, a thickness of each layer shown in FIG. 1 is excessively extended.

Referring to FIGS. 1 and 2, in an embodiment of the present invention, in order to freely change a color painted on the body panel to glossy or matte, a liquid crystal film layer 300 including a liquid crystal material whose transmittance is converted according to voltage application instead of the existing matte PPF is attached to a body panel 100.

Specifically, a paint layer 200 is coated on the body panel 100, and the liquid crystal film layer 300, instead of the existing matte PPF, is attached on the paint layer 200.

The liquid crystal film layer 300 may be attached on the paint layer 200 using, for example, an adhesive or a double-sided adhesive tape.

The liquid crystal film layer 300 includes two transparent electrode layers 310 and 330 and a liquid crystal layer 320 interposed between the transparent electrode layers. In this specification, for convenience, the transparent electrode layer 310 disposed on the liquid crystal layer 320 is referred to as an ‘upper transparent electrode layer’, and the transparent electrode layer 330 disposed below the liquid crystal layer 320 is referred to as a ‘lower transparent electrode layer’.

The upper and lower transparent electrode layers 310 and 330 may each be formed of an indium tin oxide (ITO) material.

The upper transparent electrode layer 310 may be, for example, electrically connected to a positive (+) terminal of a power supply unit 20 through a switch 10, and the lower transparent electrode layer 330 may be electrically connected to a negative (−) terminal of the power supply unit 20.

In this connection structure, as shown in FIG. 2, when the switch 10 is turned on, a voltage is applied to the upper and lower transparent electrode layers 310 and 330, and as shown in FIG. 1, when the switch 10 is turned off, voltage supply to the upper and lower transparent electrode layers 310 and 330 is stopped.

When a voltage is applied to the upper and lower transparent electrode layers 310 and 330, an electric field is generated in the liquid crystal layer 300, and according to this electric field, an arrangement structure of liquid crystal molecules 322 included in the liquid crystal layer 300 is changed.

For example, as shown in FIG. 1, when the switch 10 is turned off, that is, when no voltage is applied to the upper and lower transparent electrode layers 310 and 330, the liquid crystal molecules 322 of the liquid crystal layer 320 are arranged in a direction horizontal to the paint layer 200.

When the liquid crystal molecules 322 are arranged in the horizontal direction, the transmittance of the liquid crystal layer 320 is lowered and converted to an opaque state, and light reflected by the paint layer 200 is scattered and blocked by the liquid crystal layer 320 converted in the opaque state, and thus, the color of the paint layer 200 is visually recognized as a matte color.

As shown in FIG. 2, when the switch 10 is turned on, that is, when a voltage is applied to the upper and lower transparent electrode layers 310 and 330, the liquid crystal molecules 322 of the liquid crystal layer 320 are arranged in a direction perpendicular to the paint layer 200.

When the liquid crystal molecules 322 are arranged in a vertical direction, the transmittance of the liquid crystal layer 320 increases, the liquid crystal layer 320 is converted to a transparent state, and light reflected by the paint layer 200 is recognized as a glossy color by the liquid crystal layer 320 converted to a transparent state.

As such, in the present invention, by controlling the transmittance of the liquid crystal layer 300 attached to the paint layer 200 through the switching operation of the switch 10 for controlling voltage supply, the color of the paint layer 200 painted on the body panel may be freely change and selected to glossy or matte.

Meanwhile, although an example in which the transmittance of the liquid crystal layer increases when a voltage is applied is described in FIGS. 1 and 2, it is natural that a liquid crystal layer in which the transmittance of the liquid crystal layer decreases when a voltage is applied may also be used.

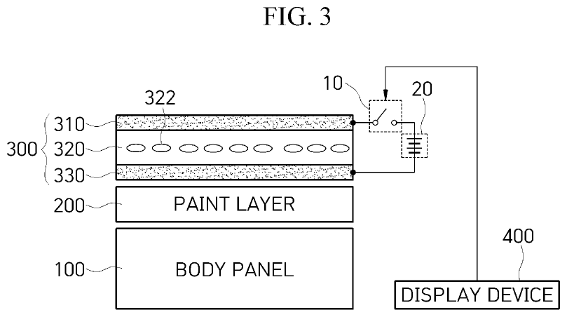

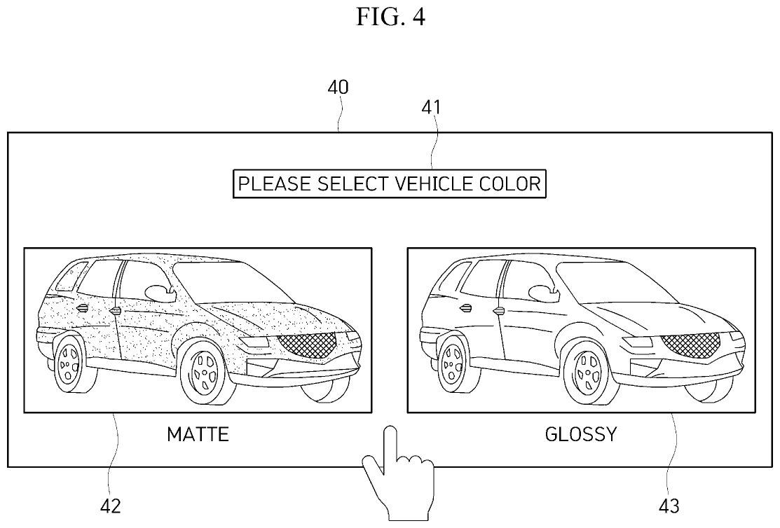

FIG. 3 is a view illustrating an apparatus for changing a color painted on a body panel to glossy or matte according to an embodiment of the present invention, and FIG. 4 is a view illustrating a screen configuration of an input screen provided by a display device shown in FIG. 3.

Referring to FIG. 3, an apparatus for changing a color painted on a body panel to glossy or matte according to an embodiment of the present invention includes the liquid crystal film layer 300 attached to the paint layer 200, a power supply unit 20 applying a voltage to liquid crystal film layer 300 and a switch unit 10 controlling an electrical connection between the liquid crystal film layer 300 and the power supply unit 20, and further includes a display device 400. Descriptions of the liquid crystal film layer 300, the power supply unit 20, and the switch 10 are replaced with those described in FIGS. 1 and 2.

The display device 400 is configured to output a switching signal for controlling an ON/OFF operation of the switch 10 may be a device providing graphics user interface (GUI) such as a cluster (instrument cluster, instrument panel) or audio, video, navigation telematics) terminal installed in a vehicle.

The user may freely change the color of the paint layer 200 painted on the vehicle panel 100 to glossy or matte through an input screen 40 (in FIG. 4) provided by the display device 400.

As shown in FIG. 4, a guide phrase “Please select a vehicle color” may be displayed on the input screen 40.

In addition, icons 42 and 43 in the form of a vehicle image for selecting matte and glossy may be further displayed on the input screen 40.

When the user touches the icon 42 in the form of a vehicle image representing a matte color, the display device 400 generates an OFF signal for turning off the switch unit 10, and transmits the OFF signal to the switch unit 10.

According to the OFF signal from the display device 400, the switch unit 10 electrically separates the power supply unit 20 from the liquid crystal film layer 300, and accordingly, the liquid crystal film layer 300 is switched to be opaque, light reflected by the paint layer 200 is scattered and blocked by the liquid crystal film layer 300 converted into an opaque state, and thus, the color of the paint layer 200 is changed to a matte color.

Alternatively, when the user touches the icon 43 in the form of a vehicle image representing a glossy color, the display device 400 generates an ON signal for turning on the switch unit 10, and transmits the ON signal to the switch unit 10.

According to the ON signal from the display device, the switch unit 10 electrically connects the power supply unit 20 and the liquid crystal film layer 300, and a voltage from the power supply unit 20 is applied to the liquid crystal film layer 300. Accordingly, the liquid crystal film layer 300 is switched to a transparent state, and light reflected by the paint layer 200 is transmitted through the liquid crystal layer 320 converted to a transparent state, so that the color of the paint layer 200 is changed to a glossy color.

Meanwhile, communication between the display device 400 and the switch unit 10 may be wired communication, and the wired communication may be, for example, CAN communication or LIN communication.

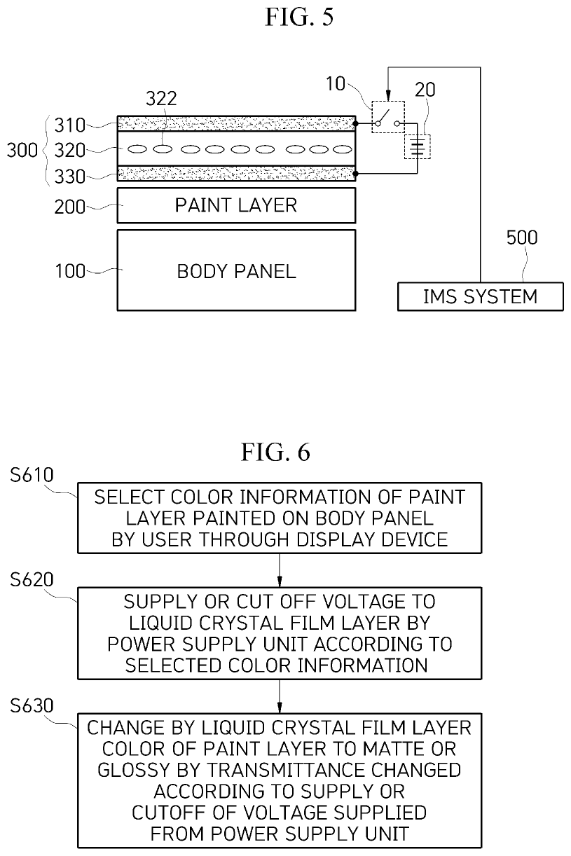

FIG. 5 is a view illustrating an apparatus for changing a color painted on a body panel to glossy or matte according to another embodiment of the present invention.

Referring to FIG. 5, the apparatus according to another embodiment of the present invention is different from the embodiment of FIG. 3 in that the display device 400 shown in FIG. 3 is replaced with an integrated memory system (IMS) system 500.

The IMS system is a system storing an optimal driving position for a driver and automatically adjusting a driving posture as stored when the driver gets in.

For example, the IMS system adjusts a seat position, steering height and depth, side mirror angle, cluster brightness, head-up display position and brightness, which have been adapted to the driver's body shape as soon as the driver gets in the driver's seat.

Such an IMS system is a system that may be very usefully applied to a vehicle in which drivers are changed frequently, and another embodiment of the present invention adds a function of selectively changing a color painted on a body panel to the IMS system.

In another embodiment of the present invention, the driver may store the color of an exterior paint preferred by the driver using a setting button of the IMS system 500.

For example, the setting button of the IMS system 500 may be usually disposed on the door handle side or together with a button for adjusting an electronic seat, and after determining the color of the paint layer preferred by the driver while the engine is turned on, when the driver selects a number to be stored through the setting button (SET), a setting storage confirmation message is displayed on a display.

In the method of regenerating the stored color of the paint layer, first, an automatic transmission lever is positioned to P when the engine is turned on, and then No. 1 or 2, which indicates the stored color of the paint layer, may be pressed, thereby adjusting the color of the paint layer to glossy or matte preferred by the driver.

That is, when the driver presses the stored number using the setting button of the IMS system 500, the IMS system 500 transmits an ON or OFF signal to the switching unit 10.

The switching unit 10 applies a voltage to the liquid crystal film layer 300 or cut off the voltage supplied to the liquid crystal film layer 300 according to the ON or OFF signal received from the IMS system 500, so that the transmittance of the liquid crystal film layer 300 is changed and the color of the paint layer 200 may be freely changed to glossy or matte by the liquid crystal film layer 300 whose transmittance is converted.

Meanwhile, communication between the IMS system 400 and the switch unit 10 may be wired communication, and the wired communication may be, for example, CAN communication or LIN communication.

FIG. 6 is a flowchart illustrating a method for changing a color painted on a body panel to glossy or matte according to an embodiment of the present invention.

Referring to FIG. 6, first, in S610, a process of outputting, by the display device 400 of FIG. 3, any one color information selected by the user from among a glossy color and a matte color is performed.

Next, in S620, a process of supplying or cutting off a voltage to the liquid crystal film layer attached to the paint layer painted on the body panel is performed by the power supply unit 20 according to the any one color information.

Next, in S630, the liquid crystal film layer is switched to an opaque state or a transparent state according to the voltage supplied or cut off from the power supply unit, and scatters and blocks light reflected by the paint layer in the opaque state to change the color of the paint layer to a matte color or changing the color of the paint layer to a glossy color in the transparent state.

In an embodiment, the supplying or cutting off a voltage to the liquid crystal film layer may be a process of changing a color painted on the body panel to glossy or matte, in which the switching unit controlling an electrical connection between the power supply unit and the liquid crystal film layer performs a switching operation according to the color information to supply or cut off a voltage to the liquid crystal film layer.

In an embodiment, the outputting of any one color information selected by the user may include: displaying, by the display device, a first icon of a vehicle image representing a matte color and a second icon of a vehicle image representing a glossy color; and selecting, by the user, any one of the first and second icons and outputting the any one color information.

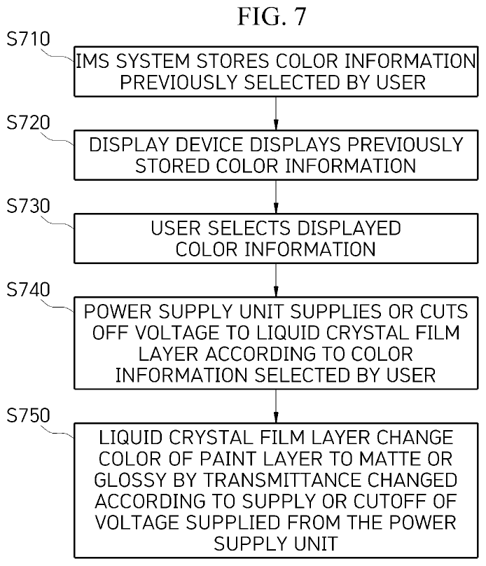

FIG. 7 is a flowchart illustrating a method for changing a color painted on a body panel to glossy or matte according to another embodiment of the present invention.

Referring to FIG. 7, first, in S710, a process of storing any one color information previously selected by the user from among a glossy color and a matte color by the integrated memory system (500 of FIG. 5) is performed.

Next, in S720, a process of displaying, by the display device, the any one color information is performed.

Next, in S730, a process for the user to select any one color information being displayed is performed.

Next, in S740, a process of supplying or cutting off a voltage to the liquid crystal film layer attached to the paint layer painted on the body panel is performed by the power supply unit according to any one of the color information.

Next, in S750, the liquid crystal film layer changes the color of the paint layer to a matte or glossy color by the transmittance changed according to the supply or cutoff of a voltage supplied from the power supply unit.

In an embodiment, the process of storing any one color information may be a process of storing any one color information previously selected by the user from among a glossy color and a matte color using a setting button of the integrated memory system.

In an embodiment, in the process of supplying or cutting off a voltage to the liquid crystal film layer, a switching unit that controls the electrical connection between the power supply unit and the liquid crystal film layer may perform a switching operation according to the color information to supply or cut off a voltage to the liquid crystal film layer.

In an embodiment, the changing includes a process in which the transmittance of the liquid crystal layer in the liquid crystal film layer is reduced to switch to the opaque state when the voltage supplied from the power supply is cut off, and a process in which light reflected on the paint layer is scattered and blocked in the opaque state to change the color of the paint layer to a matte color.

In an embodiment, the changing may include a process in which when a voltage is supplied from the power supply unit, the transmittance of the liquid crystal layer in the liquid crystal film layer increases to switch to the transparent state and the color of the paint layer is changed to a glossy color by light reflected on the paint layer in the transparent state.

According to the present invention, a color of a body panel may be freely selected to glossy or matte without a new painting operation for a single vehicle or a film operation for matte, thereby satisfying various consumer demands for the color of the body panel and a purchasing power of consumers may be increased.

It will be apparent to those skilled in the art that various modifications and variations may be made in the present invention without departing from the spirit or scope of the inventions. Thus, it is intended that the present invention covers the modifications and variations of this invention provided they come within the scope of the appended claims and their equivalents.

What is claimed is:

1. An apparatus for changing a color painted on a body panel to glossy or matte, the apparatus comprising:
a liquid crystal film layer attached to a paint layer painted on the body panel; and
a power supply configured to supply a voltage to the liquid crystal film layer,
wherein the liquid crystal film layer is changed to an opaque state or a transparent state depending on whether the voltage is supplied, scatters and blocks light reflected on the paint layer in the opaque state to change a color of the paint layer into a matte color, and changes the color of the paint layer into a glossy color in the transparent state.

2. The apparatus of claim 1, wherein
the liquid crystal film layer includes:
an upper transparent electrode connected to one terminal of the power supply;
a lower transparent electrode connected to the other terminal of the power supply; and
a liquid crystal layer interposed between the upper transparent electrode and the lower transparent electrode and switched to the opaque state or the transparent state depending on whether the voltage is supplied or not.

3. The apparatus of claim 1, further comprising:
a switching device controlling electrical connection of the liquid crystal film layer and the power supply according to a switching operation of the switching device,
wherein the liquid crystal film layer is changed to the opaque state or the transparent state according to the switching operation of the switching device.

4. The apparatus of claim 1, further comprising:
a switching device controlling an electrical connection between the liquid crystal film layer and the power supply according to ON and OFF operations of the switching device; and
a display device installed in a vehicle, providing an input function to select one of the glossy color and the matte color, and outputting a switching signal for controlling the ON and OFF operations of the switching device according to a color selected by the user through the input function.

5. The apparatus of claim 4, wherein the display device is an instrument cluster or audio, video, navigation, telematics (AVNT) terminal.

6. The apparatus of claim 1, further comprising:
a switching device controlling an electrical connection between the liquid crystal film layer and the power supply according to ON and OFF operations of the switching device; and
an integrated memory system installed in a vehicle, storing one color information selected by the user from among the glossy color and the matte color through a setting button in advance, and outputting a switching signal for controlling the ON and OFF operations of the switching device when the user selects one previously stored color information displayed through a display device in the vehicle.

7. A method for changing a color painted on a body panel to glossy or matte, the method comprising:
outputting, by a display device, color information selected by a user from among a glossy color and a matte color;
supplying, by a power supply, a voltage to a liquid crystal film layer attached to a paint layer painted on the body panel or cutting off the voltage according to the color information; and
changing, by the liquid crystal film layer, a color of the paint layer into the matte color or the glossy color based on a changed transmittance according to the voltage supplied or cut off from the power supply.

8. The method of claim 7, wherein
the supplying of the voltage to the liquid crystal film layer or cutting off the voltage includes:
performing, by a switching device controlling an electrical connection between the power supply and the liquid crystal film layer, a switching operation according to the color information to supply or cut off the voltage to the liquid crystal film layer.

9. The method of claim 7, wherein
the outputting of the color information selected by the user includes:
displaying, by the display device, a first icon of a vehicle image representing the matte color and a second icon of a vehicle image representing the glossy color;
outputting the color information by the user selecting one of the first and second icons.

10. A method for changing color painted on a body panel to glossy or matte, the method comprising:
storing, by an integrated memory system, color information selected by a user in advance from among a glossy color and a matte color;
displaying, by a display device, the color information and outputting the color information when the user selects the color information being displayed;
supplying, by a power supply, a voltage to a liquid crystal film layer attached to a paint layer painted on the body panel according to the color information or cutting off the voltage; and
changing a color of the paint layer to the matte color or the glossy color based on transmittance changed as the voltage supplied from the power supply is supplied or cut off.

11. The method of claim 10, wherein
the storing of the color information includes:
storing color information previously selected by a user from among the glossy color and the matte color by using a setting button of the integrated memory system.

12. The method of claim 10, wherein
the supplying or cutting off the voltage to the liquid crystal film layer includes:
supplying or cutting off the voltage to the liquid crystal film layer by performing a switching operation by a switching device controlling an electrical connection between the power supply and the liquid crystal film layer according to the color information.

13. The method of claim 10, wherein
the changing includes:
reducing transmittance of a liquid crystal layer in the liquid crystal film layer to switch to an opaque state when the voltage supplied from the power supply is cut off; and
changing the color of the paint layer to the matte color by scattering and blocking light reflected on the paint layer in the opaque state.

14. The method of claim 10, wherein
the changing includes:
increasing transmittance of a liquid crystal layer in the liquid crystal film layer to switch to a transparent state when the voltage is supplied from the power supply; and
changing the color of the paint layer to the glossy color by light reflected on the paint layer in the transparent state.
